(19) United States
(12) Patent Application Publication
(10) Pub. No.: US 2013/0341556 A1
(43) Pub. Date: Dec. 26, 2013

(54) USE OF POLYMER DISPERSIONS AS HEAT EXCHANGE FLUIDS

(71) Applicants: Manuel Hidalgo, Brignais (FR); Gilles Barreto, Messimy (FR); Frederick Mantisi, Lyon (FR)

(72) Inventors: Manuel Hidalgo, Brignais (FR); Gilles Barreto, Messimy (FR); Frederick Mantisi, Lyon (FR)

(73) Assignee: CECA S.A., La Garenne Columbes (FR)

(21) Appl. No.: 13/985,160

(22) PCT Filed: Feb. 10, 2012
(86) PCT No.: PCT/FR2012/050305

§ 371 Date: Sep. 13, 2013

(30) Foreign Application Priority Data
Feb. 14, 2011 (FR) 1151176

(51) Int. Cl. C09K 5/06

(52) U.S. Cl. CPC C09K 5/063
USPC 252/78.1; 252/73; 252/77

(57) ABSTRACT

Heat exchange fluids comprising an aqueous or aqueous-organic dispersion are disclosed. The dispersions have a purely or predominantly aqueous continuous liquid phase, and at least one dispersed phase comprising particles of at least one polymer. Systems for exchanging or storing heat using the heat exchange fluid are also disclosed.

### CROSS REFERENCE TO RELATED APPLICATIONS

This application is the U.S. National Phase application of PCT International Application No. PCT/EP2012/0500305, filed Feb. 10, 2012, and claims priority to French Patent Application No. 1151176, filed Feb. 14, 2011, the disclosures of which are incorporated by reference in their entirety for all purposes.

### FIELD OF THE INVENTION

The present invention relates to the use of polymer dispersions as heat-exchange fluids. The present invention also relates to heat-exchange and heat storage systems, and the like, comprising at least one polymer dispersion as heat-exchange fluid.

### BACKGROUND OF THE INVENTION

By virtue of its physicochemical characteristics such as, inter alia, its low viscosity, its high heat capacity, its abundance and its wide temperature range during which it remains in the liquid state, water is a thermal fluid of first choice for uses such as heat exchange (cooling, heating), heat storage (systems with a reserve, storage tank, cylinder), etc.

However, liquid water as an exchange fluid can exchange or store/release only “sensitive” heat, in accordance with the following formula:

Q_{water}=mass of water×heat capacity at constant pressure×(Tf−Ti)

in which Q_{water} represents the amount of heat exchanged, and (Tf−Ti) represents the temperature interval (final and initial) involved in the exchange, absorption or release of heat.

For example, 1 g of liquid water going from a temperature of 45° C. to 55° C. stores an amount of sensitive heat of about 42 J.

Water therefore has many advantages, for example in terms of fluidity, viscosity, abundance, cost, or large working temperature range. On the other hand, water can exchange or store/release only sensitive heat, and, consequently, water proves to be a heat-exchange fluid of relatively poor efficacy, although used at the present time in numerous heat-exchange or heat-storage systems.

In order to be able to exchange more heat than the sensitive heat using water, one solution might consist in also using the latent heat of fusion/crystallization or condensation/evaporation of water.

For example, 1 g of water which passes from the liquid state to the vapor state at 100° C. stores 2260 J. At 60° C., the heat stored by evaporation is 2360 J, which is advantageous from the thermal point of view. The drawback of using this phase transition is that steam is generated, which thus entails risks of leaks and consequently a loss of efficacy.

It would thus appear to be advantageous to have a heat-exchange fluid which can conserve the essence of the advantageous characteristics of liquid water (viscosity, working temperatures, inter alia), but which has a capacity for exchange, adsorption and release of energy higher than that of liquid water.

One of the solutions that may be envisaged for obtaining such a heat-exchange fluid might consist in dispersing in water a material having an available energy reserve higher than that of water. However, since liquid water is already per se one of the highest sensitive heat reserve materials, it proves to be difficult to find materials with a higher sensitive heat reserve and which are readily available and inexpensive.

Numerous research studies have thus been conducted in order to find materials which, in the working temperature range of liquid water as heat-exchange fluid, have solid/liquid phase transitions involving not sensitive heat, but latent heat.

To increase the energy efficiency of exchange fluids, and in particular of water, dispersions of phase-change materials (PCM) in water are known. However, these dispersions are often coarse or relatively unstable, which leads to drawbacks for the transfer of heat or for the circulation or flow of the thermal fluid.

It appears at the present time that the materials of choice for dispersion in water, which have an advantageous phase transition for the envisioned applications, are essentially paraffins, as is proposed, for example, in patent application EP-A2-2 127 737.

Similarly, patent application JP 6050685 describes the use, as a cold-storage system, of a dispersion of paraffins, fats, oils and the like, in an aqueous or aqueous-organic dispersing phase, the diameter of the dispersed particles being between 0.2 μm and 50 μm.

These dispersed systems are phase-change material (PCM) systems having melting/crystallization transitions in temperature ranges which may vary, according to the length of the paraffin chain and the type of fat or oil used, typically between 0° C. and 100° C. The advantages of paraffins are their high crystallinity (which gives high latent heats) and their low cost.

However, the drawbacks of these paraffins, oils or fats are manifold: they are relatively difficult to disperse in water by themselves; the size of the dispersed particles cannot reach a value low enough to conserve the main advantages of water, especially a low viscosity; the dispersion of paraffins in water is often unstable and very rapidly changes into a macro-dephased system which may become troublesome, or even prohibitive, for the majority of applications.

Patent application JP 2009/046638A describes the emulsion polymerization of (meth)acrylic acid esters in the presence of mineral particles dispersed in the organic phase, which particles form a shell around the polymer particles once the emulsion is obtained. These resulting particles have a median diameter of between 5 and 100 μm, are heavier than water and decant, and are used as phase-change materials, optionally after drying, in hydraulic compositions such as cements, concretes or mortars.

Thus, there is not at the present time in the prior art any description of liquid systems for heat exchange, heat storage, and the like, having an aqueous or aqueous-organic continuous phase, with a viscosity comparable to that of water, or at the very least having a low viscosity, and which are stable over time and under the working conditions.

In addition, it would be advantageous to have available heat-exchange systems which have a content of starting materials of renewable origin higher than that of the systems using paraffins or olefins, and which have higher thermal power, especially when compared with the heat-exchange systems known in the prior art.

### SUMMARY OF THE INVENTION

The inventors have now discovered that it is possible to obtain fluid and stable aqueous dispersions of polymers, which make little or no modification of the physical properties of the water, while at the same time providing a large amount of latent heat to said polymer dispersions. It was in particular observed that this latent heat is about 10% to 30% higher than the latent heat of the dry polymer. In addition, it is surprising to observe that it is possible to obtain with this system a crystallization that shows only one exothermic peak, despite the microscopic size of the particles.

Thus, according to one aspect, the present invention relates to the use, as a heat-exchange fluid, of an aqueous or aqueous-organic dispersion, comprising a purely or predominantly aqueous continuous liquid phase, and at least one dispersed phase comprising particles of at least one polymer.

Another aspect of the present invention relates to a system for exchanging or storing heat, comprising a heat-exchange fluid, wherein the heat-exchange fluid is an aqueous or aqueous-organic dispersion, comprising a purely or predominantly aqueous continuous liquid phase, and at least one dispersed phase comprising particles of at least one polymer.

According to another aspect, the present invention relates to a heat-exchange fluid, comprising an aqueous or aqueous-organic dispersion, comprising a purely or predominantly aqueous continuous liquid phase, and at least one dispersed phase comprising particles of at least one polymer, wherein the dispersion comprises (per 100 parts by weight) at least the constituents A to D, wherein:

A: from 5 to 70 parts by weight of one or more homopolymers and/or copolymers chosen from:
polymers of “comb” type, polymers of “ladder” type, and/or polymers of “star” type;
acrylic and/or methacrylic homopolymers or copolymers and olefinic homopolymers or copolymers;
at least one polymer results from the copolymerization of at least one ethylenically unsaturated monomer substituted with at least one fatty alkyl chain comprising from 9 to 50 carbon atoms, and of at least one comonomer chosen from C₁ to C₈ alkyl (meth)acrylates, C₁ to C₈ alkyl(meth)acrylamides, α-olefins substituted with a C₁ to C₈ alkyl radical, and also mixtures of two or more of the comonomers mentioned above, in all proportions; and
at least one polymer is a homopolymer or copolymer, the units of which are derived:
A1: from 50% to 100% by weight of one or more monomers chosen from alkyl (meth)acrylate units or homopolymers or copolymers comprising alkyl(meth)acrylamide units, wherein the alkyl group represents a linear or branched hydrocarbon-based chain comprising from 9 to 50 carbon atoms, and ethylenically unsaturated monomer(s) substituted with an alkyl chain comprising from 9 to 50 carbon atoms,
A2: from 0 to 50% by weight of one or more comonomers chosen from at least one ethylenically unsaturated monomer substituted with at least one fatty alkyl chain comprising from 9 to 50 carbon atoms, C₁ to C₈ alkyl (meth)acrylates, C₁ to C₈ alkyl(meth)acrylamides, and α-olefins substituted with a C₁ to C₈ alkyl radical,
   A3: from 0 to 50% by weight of one or more polar comonomers chosen from (meth)acrylamides and derivatives thereof, dialkylaminoethyl (meth)acrylates, monoolefinic derivatives of sulfonic and phosphoric acid, N-vinylpyrrolidone, vinylpyridine and derivatives thereof, hydroxyalkyl (meth)acrylates, and also mixtures of two or more thereof in all proportions, and
   A4: from 0 to 40% by weight of one or more comonomers chosen from monocarboxylic and/or dicarboxylic acids or anhydrides, comprising at least one ethylenic unsaturation;

B: from 0 to 30 parts by weight of a cosolvent or of a mixture of cosolvents chosen from ketones, aromatic solvents, plant or mineral oils, and also mixtures of one or more thereof in all proportions;

C: from 0 to 40 parts by weight of at least one water-miscible cosolvent chosen from alcohols, diols and polyols, glycols and polyglycols, (poly)glycol ethers or esters, sugars and derivatives thereof, and also mixtures of two or more thereof, in all proportions;

D: from 0.1 to 30 parts by weight of one or more surfactants chosen from ionic surfactants, nonionic surfactants, protective colloids, amphiphilic polymers chosen from fatty alkyl or alkylphenyl sulfates or sulfonates, alkylbenzene sulfonates and sulfosuccinates, quaternary ammonium salts, and ethoxylated fatty alcohols; and

E: water in a sufficient quantity (qs) to make all of the constituents A to E up to 100 parts by weight.

### DETAILED DESCRIPTION OF THE INVENTION

According to one embodiment, the dispersion (or latex) is characterized in that the polymer(s) dispersed in the water are synthesized by standard aqueous emulsion polymerization, in aqueous miniemulsion or in aqueous microemulsion, according to the methods known to those skilled in the art and described in the literature, for example in the book “Les latex synthétiques: Élaboration, Propriétés, Applications [Synthetic latices: Production, properties and applications]”, coordinated by Jean-Claude Daniel and Christian Pichot, published in France by Lavoisier Tec. & Doc. (2006).

Other characteristics intrinsic to these latices, which are necessary for their use as heat-exchange systems, are their low viscosity, or at the very least their viscosity close to that of water, their stability, in particular when the dispersed polymer particles undergo phase transitions (melting or crystallization).

For the purposes of the present invention, the term “dispersion” means a dispersion of particles of at least one polymer in an aqueous or aqueous-organic fluid, in which the dispersed particles have a median diameter of less than 4 μm, preferably less than 2 μm, more preferably less than 1 μm and most preferably less than or equal to 500 nm.

Without introducing any limiting nature, the median diameter of said particles is generally greater than 100 nm and more generally greater than 150 nm. In a most particularly preferred embodiment, the median diameter of the particles is between 100 nm and 1 μm and even more preferentially between 150 nm and 500 nm.

The term “continuous phase” means the continuous phase of the dispersion comprising water, or any water/organic compound mixture, said organic compound being chosen from solvents (one or more), the only condition being that the solvent(s) do not form a single phase with the water, throughout the working temperature range.

The term “low viscosity” means a dynamic viscosity of less than 1000 mPa·s, preferably less than 500 mPa·s, more preferably less than 100 mPa·s and even more preferably less than 50 mPa·s, at 25° C., measured using a Rheomat viscosimeter.

For the purposes of the present invention, it is preferred to use polymers with a phase-change (melting/crystallization) enthalpy of greater than 30 J/g and preferably greater than 50 J/g. In this context, the phase-change enthalpy is measured by differential scanning calorimetry (DSC).

The term “stability” of the dispersion (or of the latex) means a dispersion which remains liquid and homogeneous, and for which no macro-separation of the phases with a subnatant of water or of aqueous-organic phase, or any deposition, precipitation or creaming of the aggregated polymer particles or sudden change of viscosity is observed, over a period of more than 1 day, preferably of more than 2 days, more preferably of more than 7 days, more preferentially of more than 21 days, without the dispersion being shaken or subjected to any constraint.

Preferably, the latex filtered at the end of polymerization during the emptying of the reactor through a 100 μm mesh leaves an amount of residue on the filter of less than 5% by weight relative to the total filtered weight, and even more preferably less than 1% by weight relative to the total filtered weight.

In contrast with the dispersions of phase-change materials (PCM) known and described to date in the literature, the latex used in the context of the present invention allows the production of phase-change systems which are fluid, sparingly viscous, stable, and thermally more efficient than water.

Thus, the latices (or dispersions) of the present invention have rheological behavior that is entirely comparable to that of water, while at the same time having thermal storage and restitution characteristics that are superior to those of water, and may advantageously replace water in any type of heat-exchange system.

As indicated previously, the latex used in the context of the present invention comprises at least one dispersing phase and at least one polymer dispersed in said aqueous or aqueous-organic dispersing phase which is continuous, liquid and homogeneous.

The liquid continuous dispersing phase may be water or a water/(water-miscible organic compound) mixture. The water-miscible organic compound may be of any type known to those skilled in the art, and chosen from water-miscible cosolvents. This or these cosolvent(s) of the dispersing aqueous phase are noted C in the rest of the present description.

Nonlimiting examples of cosolvent(s) C for the dispersing phase that may be mentioned include cosolvents chosen from alcohols, for instance ethanol, methanol, butanol or isopropanol, diols and polyols, for instance glycols and polyglycols, glycerol, glyceryl carbonate, (poly)glycol ethers or esters, such as ethylene or propylene glycol, diethylene glycol or dipropylene glycol, preferably propylene or dipropylene glycol monomethyl or monoethyl ether, and also sugars and derivatives thereof, for instance isosorbide, dimethylisosorbide, and the like, and also mixtures of two or more thereof, in all proportions.

Among the dispersions comprising one or more water-miscible cosolvent(s), the ones that are preferred are those in which the amount of water represents more than 10%, preferably more than 20%, more preferably more than 30%, entirely preferably more than 40% and advantageously more than 50% relative to the total weight of the dispersing phase.

The liquid continuous dispersing phase may also include dissolved organic or mineral species such as mineral salts, surfactants, additives that are soluble in the continuous phase, such as anticorrosion additives, biocides, antifoam additives, buffers, tail reducers, and the like.

The dispersed phase, for its part, consists of particles that are immiscible with the continuous phase, of at least one polymer. Among the polymers that may be used in the context of the present invention, the ones that are most particularly preferred are branched polymers, and more particularly polymers of “comb” type, polymers of “ladder” type, and/or polymers of “star” type. Polymers of “comb” type are most particularly preferred.

The branched polymers may be used for the present invention advantageously have branched fatty chains, i.e. hydrocarbon-based chains comprising, for example, in a nonlimiting manner, from 9 to 50 carbon atoms, preferably from 10 to 40 carbon atoms and more preferably from 14 to 30 carbon atoms, said hydrocarbon-based chain itself possibly being linear or branched, and optionally containing one or more heteroatoms, chosen from nitrogen, oxygen, sulfur and phosphorus.

As nonlimiting examples of polymers that may be used in the dispersions (latices) according to the invention, mention may be made of homopolymers or copolymers of acrylic and/or methacrylic type, of variable composition, such as homopolymers or copolymers comprising fatty alkyl (meth)acrylate units, homopolymers or copolymers comprising fatty alkyl(meth)acrylamide units.

Among the fatty alkyl (meth)acrylate homopolymers or copolymers and fatty alkyl(meth)acrylamide homopolymers or copolymers, mention may be made, as nonlimiting examples, of those obtained by homopolymerization or copolymerization of monomer(s) chosen from lauryl acrylate, behenyl acrylate, lauryl methacrylate, behenyl methacrylate, laurylacrylamide, behenylacrylamide, laurylmethacrylamide, behenylmethylacrylamide, and the like, and also mixtures of two or more thereof in all proportions.

Among the polymers that may be used in the dispersions (latices) according to the invention, mention may also be made of homopolymers or copolymers of olefinic type, of variable composition, such as those prepared from ethylenically unsaturated monomer(s) substituted with a fatty chain as defined previously, for example homopolymers or copolymers prepared from fatty-chain α-olefins, such as vinyl versatates, vinyl laurate, vinyl behenate, or starting with polymerizable acid anhydrides substituted with fatty chain(s), for instance maleic anhydride derivatives monosubstituted with an alkyl group, or starting with vinyl monomers, such as alkyl vinyl ethers, the alkyl parts comprising from 9 to 50 carbon atoms, preferably from 10 to 40 carbon atoms and more preferably from 14 to 30 carbon atoms.

These monomers and/or comonomers bearing a fatty side chain are named Al in the rest of the present description.

In addition, it is possible to include in the monomers to be polymerized any other ethylenically unsaturated comonomer that is capable of copolymerizing with the main monomers bearing a fatty side chain defined previously. These other comonomers may be used in all proportions, preferably in a minor proportion, for the purpose, for example, of shifting, according to the needs, the melting/crystallization point or range of the phase-change polymer material (obtained with the main monomers bearing a fatty side chain) included in the dispersed phase of the latex.

Among these comonomers, nonlimiting examples that may be mentioned include those chosen from C₁ to C₈ alkyl (meth)acrylates, C₁ to C₈ alkyl(meth)acrylamides, α-olefins substituted with a C₁ to C₈ alkyl radical, such as methyl (meth)acrylate, ethyl (meth)acrylate, propyl (meth)acrylate, butyl (meth)acrylate, 2-ethylhexyl (meth)acrylate, methyl(meth)acrylamide, ethyl(meth)acrylamide, propyl(meth)acrylamide, butyl(meth)acrylamide, 2-ethylhexyl(meth)acrylamide, vinyl acetate, vinyl propionate, vinyl butyrate, vinyl pivalate, vinylaromatic monomers chosen from styrene and derivatives thereof, such as α-methylstyrene, and the like, and also mixtures of two or more of the comonomers mentioned above, in all proportions.

These comonomers bearing a short (“non-fatty”) side chain are named A2 in the rest of the present description. These comonomers A2 are preferably sparingly soluble in water, i.e. their solubility in water at 20° C. is less than 5% by weight.

Other comonomers may also be copolymerized with one or more of the monomers Al and optionally comonomers A2, defined above. These other comonomers are advantageously polar comonomers, noted A3 in the rest of the description, and may be chosen, for example, from (meth)acrylamides and derivatives thereof such as N-methylolacrylamide, dialkylaminoethyl (meth)acrylates, monoolefinic derivatives of sulfonic acid and phosphoric acid, such as acrylamidomethylpropanesulfonic acid, N-vinylpyrrolidone, vinylpyridine and derivatives thereof, hydroxylalkyl (meth)acrylates, and the like, and also mixtures of two or more thereof in all proportions.

Other comonomers may also be copolymerized with the monomers A1 and optional comonomers A2 and/or A3, as defined above. These other comonomers, noted A4 in the rest of the present description, are advantageously chosen from monomers comprising at least one ethylenic unsaturation, for example 1, 2 or 3 ethylenic unsaturations. Mixtures of comonomers A4 may be used.

Among the comonomers A4 comprising an ethylenic unsaturation, nonlimiting examples that may be mentioned include monocarboxylic and/or dicarboxylic acids or anhydrides, and in particular acrylic acid, methacrylic acid, maleic anhydride, and the like, and also mixtures of two or more thereof in all proportions.

Among the comonomers A4 comprising several ethylenic unsaturations, nonlimiting examples that may be mentioned include divinylbenzene, ethoxylated bisphenol A diacrylate, ethoxylated bisphenol A dimethacrylate, ethoxylated neopentyl glycol diacrylate, propoxylated neopentyl glycol diacrylate, ethoxylated neopentyl glycol dimethacrylate, propoxylated neopentyl glycol dimethacrylate, alkanediol diacrylates and alkanediol dimethacrylates, including 1,3-butylene glycol diacrylate, 1,6-hexanediol diacrylate and, preferentially, 1,4-butanediol diacrylate, tris(2-hydroxyethyl)isocyanurate triacrylate, trimethylpropane triacrylate, and the like, and also mixtures of two or more thereof in all proportions.

According to one embodiment of the present invention, the dispersed polymer particles are particles of at least one homopolymer and/or copolymer(s), noted A in the rest of the present description, the units of which are derived:

A1: from 50% to 100% and preferably from 70% to 100% by weight of one or more monomers Al as defined above,

A2: from 0 to 50% and preferably from 0 to 30% by weight of one or more comonomers A2 as defined above,

A3: from 0 to 50% and preferably from 0 to 30% by weight of one or more polar comonomers A3 as defined above,

A4: from 0 to 40% by weight of one or more comonomers A4 as defined above.

According to a preferred embodiment, the polymers that may be used in the dispersions of the present invention are homopolymers and copolymers of (meth)acrylic type bearing a fatty side chain, such as, as nonlimiting examples, polymers comprising alkyl (meth)acrylate and/or (meth)acrylamide units bearing a linear or branched chain comprising from 9 to 50 carbon atoms, preferably from 10 to 40 carbon atoms and more preferably from 14 to 30 carbon atoms.

The dispersed phase of the latex containing the polymer derived from the polymerizable monomers mentioned above may also contain at least one solvent, noted B hereinbelow, for the monomers, and then for the polymer, which will remain included in the particles of the final latex. It is, however, preferable, in the case where a solvent for the monomers is used, to limit its amount, or even to evaporate it off at the end of polymerization so that it does not disrupt or disrupts only very little the melting/crystallization phase change taking place within the polymer during the use of the latex.

This or these solvent(s) B are advantageously chosen from solvents for the monomers or for the final polymer, and may be chosen, for example, from ketones such as methyl ethyl ketone or methyl isobutyl ketone, aromatic solvents such as toluene, xylene and mixtures of aromatic hydrocarbons (aromatic fractions), plant or mineral oils, and the like, and also mixtures of one or more thereof in all proportions.

More specifically, the dispersions (latices) that are useful in the context of the present invention comprise (per 100 parts by weight) at least the constituents A to D below:

A: from 5 to 70, preferably from 5 to 58 and advantageously from 5 to 50 parts by weight of one or more homopolymers and/or copolymers A as defined previously; B: from 0 to 30 parts by weight of at least one solvent B for the monomers or for the polymer, preferably from 5 to 25 and advantageously from 5 to 20 parts by weight; C: from 0 to 40 parts by weight of at least one water-miscible cosolvent C, preferably from 5 to 25 and advantageously from 5 to 20 parts by weight;

D: from 0.1 to 30, preferably from 0.1 to 20, more preferably from 0.1 to 10 and, most preferably from 0.1 to 8 and advantageously from 0.5 to 5 parts by weight of one or more surfactants chosen from ionic surfactants, nonionic surfactants, protective colloids, such as polyvinyl alcohols, amphiphilic polymers chosen from fatty alkyl or alkylphenyl sulfates or sulfonates, alkylbenzene sulfonates and sulfosuccinates, quaternary ammonium salts such as dimethyldialkylammonium chlorides, and ethoxylated fatty alcohols; and

E: water in a sufficient quantity (qs) to make all of the constituents A to E up to 100 parts by weight.

The latices (or dispersions) defined above may also optionally comprise one or more other components, chosen especially from polymerization additives and/or residues thereof (initiators, buffers, transfer agents, etc.), surfactants with a hydrophilic-lipophilic balance of less than 10, preferably less than 9 and more preferably less than 8, and the like.

Advantageously, the dispersions or latices that are preferred are those comprising:

A: from about 30 to about 45 parts by weight of at least one homopolymer or copolymer, prepared from at least one monomer A1, optionally with at least one comonomer chosen from A2, A3 and A4, and as defined previously;

B: from 0 to 30 parts by weight of at least one solvent B for the monomers or for the polymer, preferably from 5 to 25 and advantageously from 5 to 20 parts by weight;

C: from about 10 to about 20 parts by weight of at least one water-miscible solvent, predominantly based on liquid polyol(s);

D: from about 1 to about 10 parts by weight of surfactants, and

E: the remainder to 100 parts by weight of water, and also at least one initiator, at least one transfer agent, at least one buffer and at least one biocidal agent.

According to a most particularly preferred embodiment, the polymer dispersed in the aqueous or aqueous-organic fluid that may be used in the context of the present invention is prepared in situ (i.e. in the aqueous or aqueous-organic medium) by emulsion radical polymerization. The latex dispersions thus obtained have the advantage of being stable, concentrated and liquid over a wide temperature range. Their polymer composition is homogeneous at the particle scale, and more particularly homogeneous from the core of the particle to the particle surface. Particles of core-shell type are not preferred.

For example, the dispersions described above may be obtained via any emulsion radical polymerization process (standard, miniemulsion or microemulsion) in water in the presence of surfactant(s) and optionally in the presence of water-miscible solvent(s).

These processes, which are well known to those skilled in the art, are described in the literature, for example in the book “Les latex synthétiques: Élaboration, Propriétés, Applications [Synthetic latices: Production, properties and applications]”, coordinated by Jean-Claude Daniel and Christian Pichot, published in France by Lavoisier Tec. & Doc. (2006), chapter 7, pages 188-189.

These processes are characterized in that the system changes from the state of a liquid/liquid emulsion of O/W (oil-in-water) type of the monomers in the aqueous or aqueous-organic continuous phase, to the state of a latex of particles containing polymer and dispersed in the aqueous or aqueous-organic continuous phase.

In all these processes, one or more surfactants and/or finely divided mineral compounds are used for the colloid stabilization, and also water-soluble or liposoluble radical polymerization initiators, depending on the case, which are water-soluble in standard emulsion, water-soluble or liposoluble in miniemulsion, and generally water-soluble in microemulsion.

The emulsion radical polymerization may advantageously be performed in a conventional manner, in any type of apparatus known for performing emulsion polymerizations in a batch, semi-batch or continuous process, without any particular intensive mixing tool (standard emulsion), or using such tools, for instance using a high-pressure emulsifier of Manton-Gaulin type or using a sonication technique to emulsify the mixture before polymerization and adopting a “miniemulsion” or “minidispersion” process, in order to reduce the amounts of organic cosolvents and of surfactants that would be otherwise necessary.

When the process is performed in miniemulsion, a costabilizer may advantageously be employed, for instance a fatty alkane or a fatty alcohol such as hexadecane or hexadecanol. The production of a very fine emulsion (median droplet diameter of less than about 1 μm) is ensured by any system known to those skilled in the art, for instance, in a nonlimiting manner, using colloidal mills, ultradispersers (for example of Ultra-Turrax type), and the like.

In the case of microemulsions, larger amounts of surfactants are generally employed, and the stability becomes independent of the time (thermodynamic stability). The final latices are often of nanometric size, with mean particle sizes of the latex of less than 50 nm in median diameter.

The polymerization also uses initiators which produce free radicals, said initiators being chosen, for example, from the usual peroxides such as persulfates, for example potassium or ammonium persulfate, hydrogen peroxide, organic peroxides and hydroperoxides, for example dibenzoyl peroxide, bi(3-methylbenzoyl) peroxide, tert-butyl peroxy-2-ethylhexanoate, tert-hexyl peroxy-2-ethylhexanoate, but also peracids, diazo compounds, for example 4,4′-azobis(4-cyanopentanoic acid), 2,2′-azobis(2-amidinopropane) hydrochloride, 2,2′-azobis(2-methylbutyronitrile), and the like.

In certain cases, use may be made of a redox system, for example ammonium persulfate combined with sodium metabisulfite, or alternatively potassium persulfate, to work at lower temperature.

The polymerization reaction may be performed over a temperature range extending from 20° C. to 95° C., for a time which may range from 0.5 to 8 hours, according to the chosen initiation conditions.

Buffers, for instance sodium tetraborate or sodium hydrogen carbonate and chain-transfer agents, for instance alkyl mercaptans (for example n-dodecyl mercaptan) may be useful for the polymerization and for the final properties of the product.

The performance of the products of the invention may also be appreciably improved by post-addition of at least one water-miscible organic solvent, for instance those mentioned above.

As indicated above, the dispersed phase may contain, besides the polymer, other polymeric or non-polymeric compounds, for instance additives, chosen, for example, from plasticizers, heat stabilizers, biocides, mineral salts, and the like.

The dispersed phase may in particular be stabilized by surface adsorption of surfactant molecules of ionic type (cationic, anionic or amphoteric), nonionic or polymeric type (ionic or nonionic), very finely divided mineral compounds (particles with an individual size preferably less than 1 μm, preferably 500 nm, or even 100 nm in diameter) such as silica, talc, clays, titanium dioxide, calcium carbonate, etc.

The polymer dispersions which have just been described show, surprisingly, that they can be advantageously used as phase-change fluids for heat exchanges.

By virtue of their liquid state and of their viscosity that is relatively close to that of water, the polymer dispersions according to the invention may be used under conditions that are entirely similar to, or even identical to, those of circuits usually comprising water, for example in circuits involving heat exchangers, heat storage tanks, cooling/heating circuits, etc.

The temperature range of these dispersions is preferably that of liquid water, although certain compositions have lower limits of use slightly below 0° C. (while still remaining liquid). The presence of at least one polymer in the dispersion has the effect that said dispersion has, in addition to its potential reserve of sensitive heat, and intrinsic to all of the constituents of said dispersion, a reserve of latent heat originating exclusively from the polymer component dispersed in the form of particles in the aqueous or aqueous-organic medium.

When the working temperatures of the dispersions according to the invention, as heat fluid (for exchanging heat by heating or cooling another element of the heat apparatus under consideration, for instance a heat exchanger) encompass or overlap the phase-change range (melting when the latex is heated, crystallization when the latex is cooled), the heat exchanged by the latex will comprise part of the latent heat originating from the phase change of the polymer.

If the working temperatures are judiciously chosen relative to the melting/crystallization range of the polymer of the latex, so as optimally to exploit the latent heat thereof, the theoretical and experimental energy balance shows that the total heat exchanged per unit volume (or weight) of the latex is significantly higher than that exchanged by a same volume (or weight) of water. As a result, the exchangeable heat reserve of the latex is higher than that of water, making it a more efficient heat exchange fluid.

Surprisingly, the dispersions that may be used in the context of the present invention, and which have median particle diameters of between 150 nm and 500 nm, make it possible to obtain one, and usually only one, crystallization phase transition at a temperature close to that of the polymer synthesized in solvent.

The dispersions according to the present invention may be used in their native form or alternatively diluted in water in all proportions, depending on the nature of the dispersed polymers, depending on the chosen field of application, depending on the amount of heat to be exchanged or stored, and the like.

As a general rule, for the uses targeted in the present invention, the polymer dispersions comprise between 10% and 65% by weight of solids, preferably between 20% and 45% by weight, for example from about 25% to about 40% by weight of solids.

The latices of the present invention thus find uses in numerous fields in which heat exchange and/or heat storage systems take place and/or are required, for instance as heat-conducting fluids, heat reservoirs (storage and/or restitution of heat), and all other systems using phase-change materials.

The present invention also relates to heat-exchange and/or heat-storage systems comprising at least one dispersion as defined previously.

These systems may comprise, for example, standard heat exchangers, microexchangers with channels or plates in which one of the exchange fluids is liquid and usable in the temperature range in which a fluid such as water would be used, energy storage devices that are capable of absorbing and then of restituting a given amount of heat, as is the case for water storage tanks, which may, for example, also serve as energy storage buffer tanks, when large amounts of heat are rapidly released by a heat source and when it is necessary to recover it and to restitute it later.

The main advantage of heat fluids that are more efficient than water, such as those described in the present invention, is that they make it possible to design equipment which is smaller than that currently using water or aqueous fluids known in the prior art. Specifically, the systems containing the dispersions of the present invention may advantageously contain or use smaller volumes of exchange fluid.

The examples that follow illustrate the present invention without, however, involving any limiting nature and consequently cannot be considered as being liable to limit the scope of the invention as claimed.

### EXAMPLE 1

### Latex Dispersion S1

220 g of demineralized water, 2 g of sodium tetraborate (Borax), 80 g of dipropylene glycol monomethyl ether, sold by Dow Chemical under the name Dowanol® DPM, and 10 g of sodium bis(tridecylsulfosuccinate) sold by Cytec under the name Aerosol® TR70 are placed in a 1 L jacketed reactor equipped with a stirrer, a thermometer, a reflux condenser, a nitrogen inlet and a bath thermostatically maintained at 50° C.

Once the temperature of 50° C. has been reached in the medium, a mixture of 169 g of behenyl acrylate sold by Arkema under the name Norsocryl® A18-22 and 0.5 g of n-dodecyl mercaptan (Arkema) melted beforehand at 50° C. are added and the mixture is brought to 80° C.

A solution of 1 g of potassium persulfate in 20 g of demineralized water is then added over one minute. After the peak of exothermicity, the reaction is left to proceed for 2 hours, and the mixture is then cooled to room temperature.

After filtration through a 100 μm filter, which operation makes it possible to remove any “coagulum” less than 1% by weight of the total charged amount of starting materials, a stable latex dispersion with a solids content of about 35% is obtained.

The latex dispersion thus obtained, which is named S1, is used in this form.

### EXAMPLE 2

### Latex Dispersion S2

The process is performed according to the procedure described in example 1, but eliminating the dipropylene glycol monomethyl ether and replacing the 169 g of behenyl acrylate with a mixture containing 144 g of behenyl acrylate and 25 g of N-vinylpyrrolidone.

The latex dispersion thus obtained is named S2.

### EXAMPLE 3

### Latex Dispersion S3

225 g of demineralized water, 81 g of Dowanol® DPM, 18 g of Aerosol® TR70, 4 g of N-alkyldimethylbenzylammonium chloride and 14 g of Mulsifan RT 203/80 (C₁₂₋₁₅ alcohol ethoxylated with 120E and at 80% active material in water), sold by Zschimmer & Schwarz Italiana S.p.A. are placed in a 1 L jacketed reactor equipped with a stirrer, a thermometer, a reflux condenser, a nitrogen inlet and a bath thermostatically maintained at 50° C.

Once the temperature of 50° C. has been reached in the medium, a mixture of 169 g of Norsocryl® A18-22 and 0.5 g of n-dodecyl mercaptan melted beforehand at 50° C. is added, and the mixture is brought to 70° C.

A solution of 1 g of 2,2′-azobis(2-amidinopropane) in 20 g of demineralized water is then added over one minute. After the peak of exothermicity, the reaction is left to proceed for 2 hours, and the medium is then cooled to room temperature.

After filtration through a 100 μm filter, a stable latex dispersion containing about 35% solids is obtained. The latex dispersion thus obtained is noted S3.

### EXAMPLE 4

### Latex Dispersions S4 and S5

The synthesis described in example 1 is repeated, but during the cooling, 1.7 g and 3.4 g, respectively, of a nonionic surfactant of ethoxylated fatty alcohol type (sold by the company CECA under the name Remcopal® 10) are post-added, to obtain the dispersions respectively named S4 and S5.

### EXAMPLE 5

### Latex Dispersion S6

159.3 g of demineralized water, 65.2 g of dipropylene glycol monomethyl ether, sold by Dow Chemical under the name Dowanol® DPM, and 5.1 g of sodium bis(tridecylsulfosuccinate) sold by Cytec under the name Aerosol® TR70 are placed in a 1 L jacketed reactor equipped with a stirrer, a thermometer, a reflux condenser, a nitrogen inlet and a bath thermostatically maintained at 50° C.

Once the temperature of 50° C. has been reached in the medium, 3.3 g of the emulsifier Mulsifan RT 203/80 sold by Zschimmer & Schwarz Italiana S.p.A. and 1.6 g of sodium tetraborate are added; a mixture of 137 g of behenyl acrylate sold by Arkema under the name Norsocryl® A18-22 and 0.5 g of n-dodecyl mercaptan melted beforehand at 50° C. is then added, and the mixture is brought to 80° C.

A solution of 0.9 g of potassium persulfate in 30 g of demineralized water is then added over one minute. After the peak of exothermicity, the reaction is left to proceed for 2 hours, and the medium is then cooled to room temperature.

After filtration through a 100 μm filter, which operation makes it possible to remove any “coagulum” less than 1% by weight of the total charged amount of starting materials, a stable latex dispersion containing about 35% solids is obtained.

The latex dispersion thus obtained, which is named S6, is used in this form.

### EXAMPLE 6

### Comparison of the Thermal Properties of the Latices

Calorimetric measurements are taken to determine the phase change enthalpy and the heat capacity of the polymer contained in the latex particles.

The apparatus used is apparatus for DSC measurement (differential scanning calorimetry): Mettler-Toledo DSC 821. The measurements are taken on the latex, and also on the dried polymer obtained by evaporation of the volatile compounds of the latex, on a stainless steel crucible HP 30 μL and with an amount of 6 to 18 mg of latex S6. The thermal history to which the sample is subjected is as follows: 5 min at 20° C. and then a ramp at 10° C/min between 20° C. and 100° C., and then an isotherm at 100° C. for 5 min, and then a ramp at −10° C/min between 100° C. and 20° C., and then an isotherm at 20° C. for 5 min, and then a ramp at 5° C/min from 20° C. to 300° C.

DSC makes it possible to perform phase-change enthalpy and heat capacity (Cp) measurements, according to the procedures described by Fred W. Billmeyer in “Textbook of Polymer Science”, second edition, John Wiley & Sons, (1971), pp. 120-122.

For the enthalpies, a crystallization enthalpy (E) of latex S6 equal to 33 J/g, and a melting enthalpy (F) of latex S6 equal to 37 J/g are measured.

For the heat capacities, the following are observed for latex S6:
Cp latex before melting: 3.82 J/g/K;
Cp latex after melting: 3.74 J/g/K;
   i.e. on average 3.78 J/g/K.

The amount of polymer contained in latex S6 is 38% by weight.

From these data, the comparative energy capacity (exchange, absorption, release) between 1 kg of pure water and 1 kg of latex may be estimated, when the temperature range encompasses, for example, all of the phase change, for example of melting.

Assuming that all of the phase change is obtained over a range of at least 20° C., the following may be compared:
for 1 kg of water, the exchanged heat (Q_{water}) for a passage from 50° C. to 70° C. (difference of 20° C.) is, given that the Cp of water is 4.185 J/(g.K):

Q_{water}×Cp×20=1000×4.185×20=83.7 kJ;
for 1 kg of latex, by performing a similar calculation, the following is obtained:

Q_{sensitive latex}=1000×3.78×20=75.6 kJ.
for 1 kg of latex, the exchanged latent heat is:

Q_{latent latex}=m×F=1000×37 J/g=37.0 kJ.

Q_{total latex}=112.6 kJ.

The total value for the sensitive heat and latent heat of latex S6 is thus 75.6+37.0, i.e. 112.6 kJ. The heat reserve of 1 kg of latex S6 is thus about 30% higher than that of 1 kg of water.

Moreover, the heat of crystallization of latex S6 measured is 33 J, i.e. per unit mass of polymer (33/0.38) =86.8 J/100 g, whereas the heat of crystallization of the dry polymer is 78 J/100 g, i.e. a gain of more than 11% for the polymer dispersion relative to the dry polymer.

Similarly, the heat of fusion of latex S6 measured is 37 J, i.e. per unit mass of polymer (37/0.38)=97.4 J/100 g, whereas the heat of crystallization of the dry polymer is 77 J/100 g, i.e. a gain of about 26.5% for the polymer dispersion relative to the dry polymer.

### EXAMPLE 7

### Measurements of the Physical Properties of the Latices

### EXAMPLE 7a

### Measurement of the Median Diameter of Latex S6:

The median diameter is measured using a Coulter LS230 laser granulometer by dilution in water of the granulometer cuvette.

Repeated syntheses according to example 5 lead to dispersions whose particles have a median diameter of between 100 nm and 500 nm, according to the form of the stirrer and the stirring speed.

### EXAMPLE 7b

### Measurement of the Viscosity of Latex S6

The viscosity of the latex is measured using a Rheomat 180 viscosimeter, using spindle No. 11 and a spin speed of 1300 revolutions/minute.

Repeated syntheses according to example 5 lead to dispersions with a viscosity of between 15 mPa.s and 18 mPa.s.

### EXAMPLE 7c

### Measurement of the Stability on Storage of Latex S6

The stability on storage is measured in a glass bottle by observation of the appearance of the latex over two repetitions of the following thermal cycle: i) storage at rest for 2 days at 25° C. and then ii) 2 days at 0° C., and then iii) 2 days at −10° C., and then iv) 2 days at 0° C., and then v) 2 days at 25° C., and then vi) 2 days at 50° C.

The latex is solid at −10° C., and remains in the form of a homogeneous liquid at higher temperatures, even after the two cycles which last 24 hours. This clearly shows that the dispersions according to the present invention are stable.

1-13. (canceled)

14. A system for exchanging or storing heat, comprising a heat-exchange fluid, wherein the heat-exchange fluid is an aqueous or aqueous-organic dispersion, comprising a purely or predominantly aqueous continuous liquid phase, and at least one dispersed phase comprising particles of at least one polymer.

15. The system according to claim 14, wherein the dispersed particles have a median diameter of less than 4 μm.

16. The system according to claim 14, wherein the dispersed particles have a median diameter of less than or equal to 500 nm.

17. The system according to claim 14, wherein the aqueous or aqueous-organic dispersion has a dynamic viscosity of less than 1000 mPa·s at 25° C.

18. The system according to claim 14, wherein the aqueous or aqueous-organic dispersion has a dynamic viscosity of less than 50 mPa·s at 25° C.

19. The system according to claim 14, wherein the polymer dispersions comprise between 10% and 65% by weight of solids.

20. The system according to claim 14, wherein the polymer dispersions comprising between about 25% to about 40% by weight of solids

21. The system according to claim 14, wherein said at least one polymer is chosen from polymers of “comb” type, polymers of “ladder” type, and/or polymers of “star” type.

22. The system according to claim 21, wherein said at least one polymer is chosen from polymers of “comb” type.

23. The system according to claim 14, wherein said at least one polymer is chosen from acrylic and/or methacrylic homopolymers or copolymers and olefinic homopolymers or copolymers.

24. The system according to claim 23, wherein said at least one polymer is chosen from acrylic and/or methacrylic homopolymers or copolymers comprising alkyl (meth)acrylate units or homopolymers or copolymers comprising alkyl(meth)acrylamide units, wherein the alkyl group represents a linear or branched hydrocarbon-based chain comprising from 9 to 50 carbon atoms.

25. The system according to claim 23, wherein said at least one polymer is chosen from olefinic homopolymers or copolymers prepared from ethylenically unsaturated monomer(s) substituted with an alkyl chain comprising from 9 to 50 carbon atoms.

26. The system according to claim 14, wherein said at least one polymer results from the copolymerization of at least one ethylenically unsaturated monomer substituted with at least one fatty alkyl chain comprising from 9 to 50 carbon atoms, and of at least one comonomer chosen from C₁ to C₈ alkyl (meth)acrylates, C₁ to C₈ alkyl(meth)acrylamides, α-olefins substituted with a C₁ to C₈ alkyl radical, and also mixtures of two or more of the comonomers mentioned above, in all proportions.

27. The system according to claim 14, wherein said at least one polymer is a homopolymer or copolymer, the units of which are derived:
A1: from 50% to 100% by weight of one or more monomers chosen from alkyl (meth)acrylate units or homopolymers or copolymers comprising alkyl(meth)acrylamide units, wherein the alkyl group represents a linear or branched hydrocarbon-based chain comprising from 9 to 50 carbon atoms, and ethylenically unsaturated monomer(s) substituted with an alkyl chain comprising from 9 to 50 carbon atoms,
A2: from 0 to 50% by weight of one or more comonomers chosen from at least one ethylenically unsaturated monomer substituted with at least one fatty alkyl chain comprising from 9 to 50 carbon atoms, C₁ to C₈ alkyl (meth)acrylates, C₁ to C₈ alkyl(meth)acrylamides, and α-olefins substituted with a C₁ to C₈ alkyl radical,
A3: from 0 to 50% by weight of one or more polar comonomers chosen from (meth)acrylamides and derivatives thereof, dialkylaminoethyl (meth)acrylates, monoolefinic derivatives of sulfonic and phosphoric acid, N-vinylpyrrolidone, vinylpyridine and derivatives thereof, hydroxyalkyl (meth)acrylates, and also mixtures of two or more thereof in all proportions, and
A4: from 0 to 40% by weight of one or more comonomers chosen from monocarboxylic and/or dicarboxylic acids or anhydrides, comprising at least one ethylenic unsaturation.

28. The system according to claim 27, wherein said at least one polymer is a homopolymer or copolymer, the units of which are derived:
A1: from 70% to 100% by weight of one or more monomers chosen from alkyl (meth)acrylate units or homopolymers or copolymers comprising alkyl(meth)acrylamide units, wherein the alkyl group represents a linear or branched hydrocarbon-based chain comprising from 9 to 50 carbon atoms, and ethylenically unsaturated monomer(s) substituted with an alkyl chain comprising from 9 to 50 carbon atoms,
A2: from 0 to 30% by weight of one or more comonomers chosen from at least one ethylenically unsaturated monomer substituted with at least one fatty alkyl chain comprising from 9 to 50 carbon atoms, C₁ to C₈ alkyl (meth)acrylates, C₁ to C₈ alkyl(meth)acrylamides, and α-olefins substituted with a C₁ to C₈ alkyl radical,
A3: from 0 to 30% by weight of one or more polar comonomers chosen from (meth)acrylamides and derivatives thereof, dialkylaminoethyl (meth)acrylates, monoolefinic derivatives of sulfonic and phosphoric acid, N-vinylpyrrolidone, vinylpyridine and derivatives thereof, hydroxyalkyl (meth)acrylates, and also mixtures of two or more thereof in all proportions, and
A4: from 0 to 40% by weight of one or more comonomers chosen from monocarboxylic and/or dicarboxylic acids or anhydrides, comprising at least one ethylenic unsaturation.

29. The system according to claim 27, wherein the one or more polar comonomers is chosen from N-methylolacrylamide and acrylamidomethylpropanesulfonic acid.

30. The system according to claim 14, wherein the dispersion comprises (per 100 parts by weight) at least the constituents A to D below:
A: from 5 to 70 parts by weight of one or more homopolymers and/or copolymers chosen from:
polymers of “comb” type, polymers of “ladder” type, and/or polymers of “star” type;
acrylic and/or methacrylic homopolymers or copolymers and olefinic homopolymers or copolymers;
at least one polymer results from the copolymerization of at least one ethylenically unsaturated monomer substituted with at least one fatty alkyl chain comprising from 9 to 50 carbon atoms, and of at least one comonomer chosen from C₁ to C₈ alkyl (meth)acrylates, C₁ to C₈ alkyl(meth)acrylamides, α-olefins substituted with a C₁ to C₈ alkyl radical, and also mixtures of two or more of the comonomers mentioned above, in all proportions; and
at least one polymer is a homopolymer or copolymer, the units of which are derived:
A1: from 50% to 100% by weight of one or more monomers chosen from alkyl (meth)acrylate units or homopolymers or copolymers comprising alkyl(meth)acrylamide units, wherein the alkyl group represents a linear or branched hydrocarbon-based chain comprising from 9 to 50 carbon atoms, and ethylenically unsaturated monomer(s) substituted with an alkyl chain comprising from 9 to 50 carbon atoms,
A2: from 0 to 50% by weight of one or more comonomers chosen from at least one ethylenically unsaturated monomer substituted with at least one fatty alkyl chain comprising from 9 to 50 carbon atoms, C₁ to C₈ alkyl (meth)acrylates, C₁ to C₈ alkyl(meth)acrylamides, and α-olefins substituted with a C₁ to C₈ alkyl radical,
A3: from 0 to 50% by weight of one or more polar comonomers chosen from (meth)acrylamides and derivatives thereof, dialkylaminoethyl (meth)acrylates, monoolefinic derivatives of sulfonic and phosphoric acid, N-vinylpyrrolidone, vinylpyridine and derivatives thereof, hydroxyalkyl (meth)acrylates, and also mixtures of two or more thereof in all proportions, and
A4: from 0 to 40% by weight of one or more comonomers chosen from monocarboxylic and/or dicarboxylic acids or anhydrides, comprising at least one ethylenic unsaturation
B: from 0 to 30 parts by weight of a cosolvent or of a mixture of cosolvents chosen from ketones, aromatic solvents, plant or mineral oils, and also mixtures of one or more thereof in all proportions;
C: from 0 to 40 parts by weight of at least one water-miscible cosolvent chosen from alcohols, diols and polyols, glycols and polyglycols, (poly)glycol ethers or esters, sugars and derivatives thereof, and also mixtures of two or more thereof, in all proportions;
D: from 0.1 to 30 parts by weight of one or more surfactants chosen from ionic surfactants, nonionic surfactants, protective colloids, amphiphilic polymers chosen from fatty alkyl or alkylphenyl sulfates or sulfonates, alkylbenzene sulfonates and sulfosuccinates, quaternary ammonium salts, and ethoxylated fatty alcohols; and
E: water in a sufficient quantity (qs) to make all of the constituents A to E up to 100 parts by weight.

31. The system according to claim 30, wherein the dispersion comprises (per 100 parts by weight) at least the constituents A to D below:
A: from 5 to 50 parts by weight of one or more homopolymers and/or copolymers chosen from
polymers of “comb” type, polymers of “ladder” type, and/or polymers of “star” type;
acrylic and/or methacrylic homopolymers or copolymers and olefinic homopolymers or copolymers;
at least one polymer results from the copolymerization of at least one ethylenically unsaturated monomer substituted with at least one fatty alkyl chain comprising from 9 to 50 carbon atoms, and of at least one comonomer chosen from C₁ to C₈ alkyl (meth)acrylates, C₁ to C₈ alkyl(meth)acrylamides, α-olefins substituted with a C₁ to C₈ alkyl radical, and also mixtures of two or more of the comonomers mentioned above, in all proportions;
at least one polymer is a homopolymer or copolymer, the units of which are derived from A1-A4, wherein:
A1: from 50% to 100% by weight of one or more monomers chosen from alkyl (meth)acrylate units or homopolymers or copolymers comprising alkyl(meth)acrylamide units, wherein the alkyl group represents a linear or branched hydrocarbon-based chain comprising from 9 to 50 carbon atoms, and ethylenically unsaturated monomer(s) substituted with an alkyl chain comprising from 9 to 50 carbon atoms,
A2: from 0 to 50% by weight of one or more comonomers chosen from at least one ethylenically unsaturated monomer substituted with at least one fatty alkyl chain comprising from 9 to 50 carbon atoms, C₁ to C₈ alkyl (meth)acrylates, C₁ to C₈ alkyl(meth)acrylamides, and α-olefins substituted with a C₁ to C₈ alkyl radical,
A3: from 0 to 50% by weight of one or more polar comonomers chosen from (meth)acrylamides and derivatives thereof, dialkylaminoethyl (meth)acrylates, monoolefinic derivatives of sulfonic and phosphoric acid, N-vinylpyrrolidone, vinylpyridine and derivatives thereof, hydroxyalkyl (meth)acrylates, and also mixtures of two or more thereof in all proportions, and
A4: from 0 to 40% by weight of one or more comonomers chosen from monocarboxylic and/or dicarboxylic acids or anhydrides, comprising at least one ethylenic unsaturation;
B: from 5 to 20 parts by weight of a cosolvent or of a mixture of cosolvents chosen from ketones, aromatic solvents, plant or mineral oils, and also mixtures of one or more thereof in all proportions;
C: from 5 to 20 parts by weight of at least one water-miscible cosolvent chosen from alcohols, diols and polyols, glycols and polyglycols, (poly)glycol ethers or esters, sugars and derivatives thereof, and also mixtures of two or more thereof, in all proportions;
D: from 0.5 to 5 parts by weight of one or more surfactants chosen from ionic surfactants, nonionic surfactants, protective colloids, amphiphilic polymers chosen from fatty alkyl or alkylphenyl sulfates or sulfonates, alkylbenzene sulfonates and sulfosuccinates, quaternary ammonium salts, and ethoxylated fatty alcohols; and
E: water in a sufficient quantity (qs) to make all of the constituents A to E up to 100 parts by weight.

32. The system according to claim 30, wherein the cosolvent or mixture of cosolvents is chosen from methyl ethyl ketone, methyl isobutyl ketone, toluene, xylene, and mixtures of aromatic hydrocarbons.

33. The system according to claim 30, wherein the at least one water-miscible cosolvent is chosen from ethanol, methanol, butanol, isopropanol, glycerol, ethylene or propylene glycol, diethylene glycol or dipropylene glycol, propylene or dipropylene glycol monomethyl or monoethyl ether, isosorbide, and also mixtures of two or more thereof, in all proportions.

34. The system according to claim 30, wherein the one or more surfactants is chosen from such as polyvinyl alcohols and dimethyldialkylammonium chlorides.

35. The system according to claim 14, wherein the dispersion further comprises one or more other components chosen from polymerization additives and/or residues thereof, and surfactants with a hydrophilic-lipophilic balance of less than 10.

36. The system according to claim 35, wherein the dispersion further comprises one or more polymerization additives chosen from initiators, buffers, and transfer agents.

37. The system according to claim 14, wherein the system is a heat exchanger, a microexchanger with channels or plates, or an energy storage device capable of absorbing and then restituting a given amount of heat.

38. A heat exchange fluid, comprising an aqueous or aqueous-organic dispersion, comprising a purely or predominantly aqueous continuous liquid phase, and at least one dispersed phase comprising particles of at least one polymer, wherein the dispersion comprises (per 100 parts by weight) at least the constituents A to D, wherein:
A: from 5 to 70 parts by weight of one or more homopolymers and/or copolymers chosen from:
polymers of “comb” type, polymers of “ladder” type, and/or polymers of “star” type;
acrylic and/or methacrylic homopolymers or copolymers and olefinic homopolymers or copolymers;
at least one polymer results from the copolymerization of at least one ethylenically unsaturated monomer substituted with at least one fatty alkyl chain comprising from 9 to 50 carbon atoms, and of at least one comonomer chosen from C₁ to C₈ alkyl (meth)acrylates, C₁ to C₈ alkyl(meth)acrylamides, α-olefins substituted with a C₁ to C₈ alkyl radical, and also mixtures of two or more of the comonomers mentioned above, in all proportions; and
at least one polymer is a homopolymer or copolymer, the units of which are derived from A1-A4, wherein:
A1: from 50% to 100% by weight of one or more monomers chosen from alkyl (meth)acrylate units or homopolymers or copolymers comprising alkyl(meth)acrylamide units, wherein the alkyl group represents a linear or branched hydrocarbon-based chain comprising from 9 to 50 carbon atoms, and ethylenically unsaturated monomer(s) substituted with an alkyl chain comprising from 9 to 50 carbon atoms,
A2: from 0 to 50% by weight of one or more comonomers chosen from at least one ethylenically unsaturated monomer substituted with at least one fatty alkyl chain comprising from 9 to 50 carbon atoms, C₁ to C₈ alkyl (meth)acrylates, C₁ to C₈ alkyl(meth)acrylamides, and α-olefins substituted with a C₁ to C₈ alkyl radical,
